(19) United States
(12) Patent Application Publication
(10) Pub. No.: US 2010/0037320 A1
(43) Pub. Date: Feb. 11, 2010

(54) System and Method for On-Line Exchange and Trade of Information

(76) Inventors: Yuval Moed, Raanana (IL); Zeev Halevi, Haifa (IL)

Correspondence Address: The Law Office of Michael E. Kondoudis, 888 16th Street, N.W., Suite 800, Washington, DC, 20006, US

(21) Appl. No.: 12/528,108

(22) PCT Filed: Feb. 24, 2008
(86) PCT No.: PCT/IL08/00235

§ 371 Date: Aug. 21, 2009

Related U.S. Application Data
(60) Provisional application No. 60/902,524, filed on Feb. 22, 2007.

(51) Int. Cl. G06F 15/16; G06F 21/00; G06Q 30/00; G06Q 20/00; G06Q 50/00

(52) U.S. Cl. 726/24; 709/205; 705/34; 705/40

(57) ABSTRACT

A system and method for online trade and exchange information are disclosed. A computer application running on a workstation of an expert and of on workstation of a customer/patient provide an environment on the displays of the workstations which enables both parties to synchronously present and watch, modify and mark documents, video streams, documents, etc. According to embodiments of the invention a customer or patient located remotely from an expert may converse and communicate with that expert in a virtually face-to-face manner, to see and hear each other, to present documents, photos and vide streams to each other, to play and stop playing streams, to point at points of interest on their displays, etc.

### BACKGROUND OF THE INVENTION

Different kinds of on-line communication methods are available. For example, peer-to-peer Internet telephony network like Skype, video conferencing, instant messaging, chat, file sharing, shared sketch pad, are all available through the internet.

Some web sites provide services of on-line advice, for example, through video conferencing, wherein the payment may be done, for example, by a pay per minute model.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block illustration of a system for on-line exchange and trade of information according to embodiments of the present invention; and

FIGS. 2A and 2B are schematic exemplary illustrations of an expert's user interface and customer's user interface according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention may provide on-line and live consultation system and method, which may almost completely replace a face-to-face consultation session.

A system according to the present invention may enable purchasing information and advice from experts; the system may provide for the consultant and for the consulter an environment which may imitate face to face consultation and/or tuition meeting, including all means for demonstration and explanation of the subject of conversation. The system may also enable controlled payment by the consulter for the consultation session. The system may also enable the consultant to watch the payment status of the consulter.

The system may fit for substantially all kinds of consultations, including medical, legal, accounting, investments, sales and substantially all kinds of tutorials and remote learning (or e-learning). Additionally, according to some embodiments of the intention the system may provide an environment for concluding a consultation session with the execution of a purchasing act, including selection of the purchased item, execution of payment and giving of delivery details.

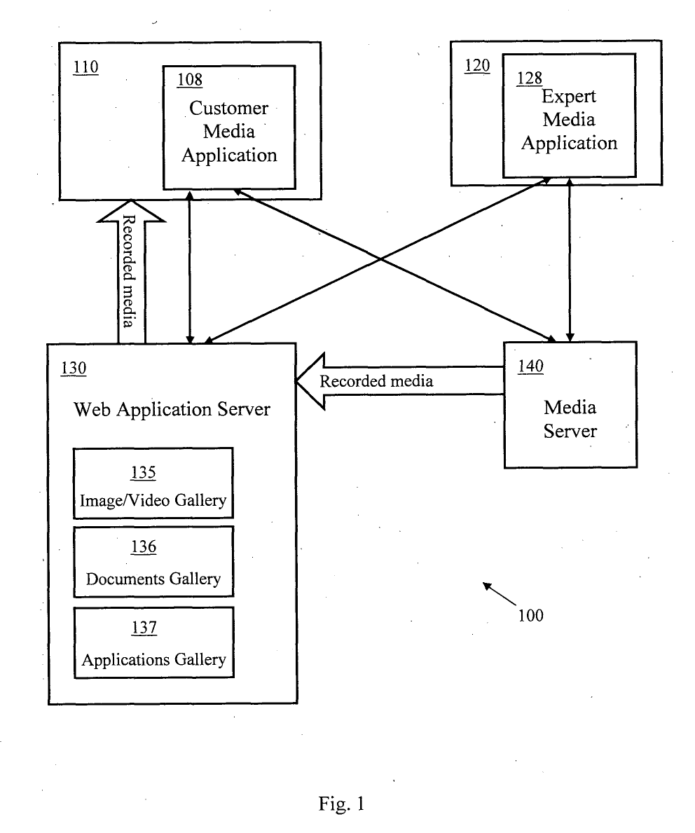

Reference is now made to FIG. 1, which is a schematic block illustration of a system 100 for on-line exchange and trade of information according to embodiments of the present invention. System 100 may include, for example, a customer's work station 110, an expert's work station 120, a web application server 130 and a media server 140. Hereinafter the term ‘customer’ may refer also to a consulter, a buyer, a remote student, etc. Customer's work station 110 and expert's work station 120 may include a customer's media application 108 and an expert's media application 128, respectively. Each of customer's media application 108 and expert's media application 128 may communicate and/or exchange data with both media server 140 and web application server 130. Each of customer's media application 108 and expert's media application 128 may be web browser plug-in software which may typically be installed in the customer's work station 110 and/or in the expert's work station 120 as part of the station, thus it may not be needed to especially install that web browser. Media server 140 may synchronize customer's media application 108 and expert's media application 128. For example, media server 140 may synchronize video, audio, chat, and/or other media in the customer's media application 108 and expert's media application 128, so that the customer and expert may view/hear the media synchronously. For applications other then media applications, such as documents browsing applications, or for other applications, synchronization of the operation of these applications may be done by web application server 130.

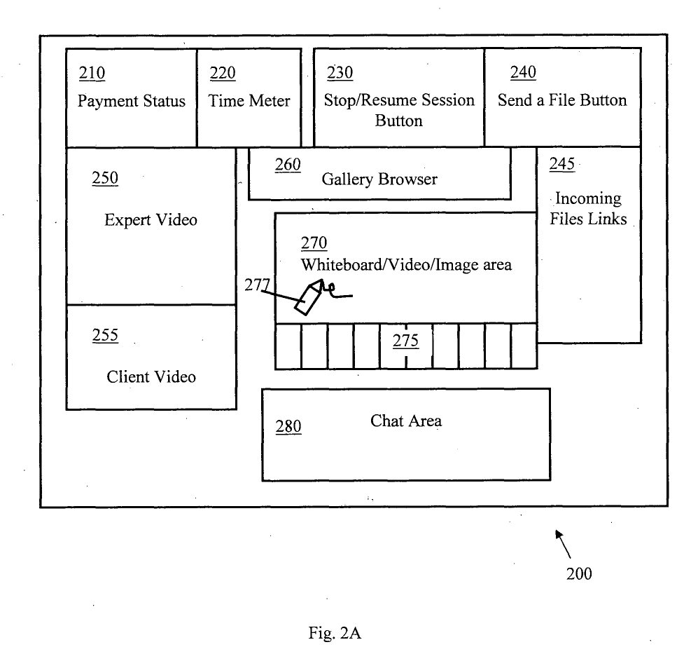

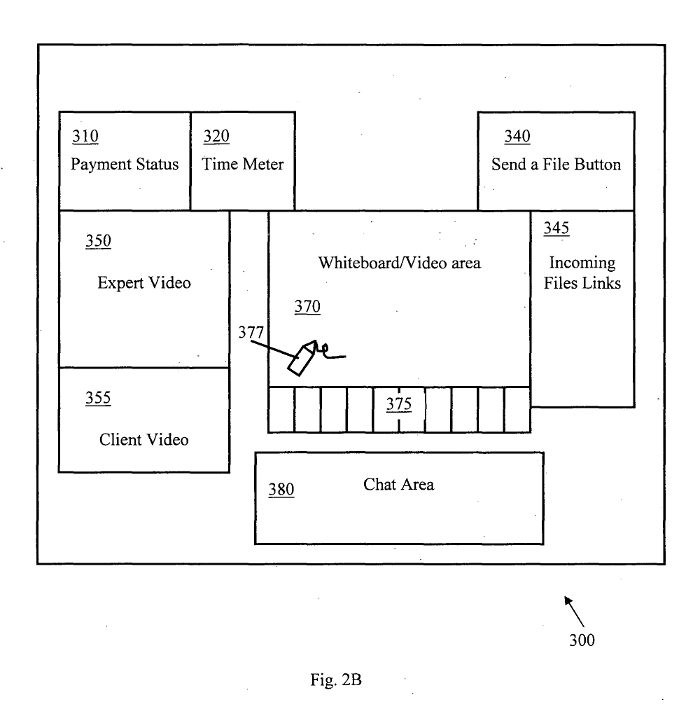

The system according to embodiments of the present invention may enable the customer to control the payment for the consultation session by controls in the user interface (shown in FIGS. 2A, 2B) of customer's media application 108. Customer's media application 108 may communicate payment instructions to web application server 130. Web application server 130 may execute the payment instructions and/or communicate the payment instructions to Expert's media application 128 which may indicate the payment status of the customer to the Expert. In yet another embodiment web application server 130 may communicate the payment instructions to an external payment service (not shown) for execution. The expert may control the session by controls in the user interface (shown in FIG. 2) of expert's media application 128. For example, the expert may stop the session or revert to a session, for example, according to the payment status of the customer. Expert's media application 128 may communicate session management instructions to web application server 130. Web application server 130 may execute the session management instructions and/or communicate the session management instructions to customer's media application 108 which may indicate the session status.

Optionally, a consultation session may be recorded, for example, in the media server, for later repeatable review. Media server 140 may transmit the recorded session to web application server 130. The customer and/or the expert may receive and watch the recorded sessions from web application server 130. In some embodiments the customer and/or the expert may save the recorded sessions in their work stations 110 and 120. These features of the present invention may be extra-charged or may be free of charge.

The system according to embodiments of the present invention may enable the customer and/or the expert to share files. For example, the customer and/or the expert may choose a file to upload and activate the sharing with the counterparty by, for example, pressing a “Send” button which may be included in the user interface (shown in FIGS. 2A and 2B) of customer's media application 108 and/or expert's media application 128. The customer and/or the expert may upload files to the web application server 130. Substantially simultaneously, a notice may be communicated to media server 130 that a new file has been uploaded. Media server 130 may update customer's media application 108 and/or expert's media application 128 respectively on the new uploaded file. Customer's media application 108 and/or expert's media application 128 may alert the customer and/or the expert respectively that a file has been uploaded and or a link may appear on the expert's/customer's screen through which the customer and/or the expert may download the file. According to embodiments of the present invention web application server 130 may coordinate and synchronize operation of applications and/or presentation and development of documents. In some embodiments, web application server 130 may perform a virus scan on the uploaded file before it can be browsed.

The system according to embodiments of the present invention may enable playing of media streams and/or presenting and modifying of files and/or presenting data synchronously by customer's media application 108 and expert's media application 128. The synchronization may be done by media server 140 or by web application server 130. In some embodiments the expert and/or customer may use one or more web cameras. The video streams received from these cameras may be displayed by customer's media application 108 and expert's media application 128 synchronously. For example, the expert and/or customer may video themselves and watch each other during the conversation synchronously, to imitate face to face conversation. Alternatively or additionally, the expert and customer may use web cameras for other purposes, for example for additional and different illustrations and demonstrations. In some embodiments, customer's media application 108 and expert's media application 128 may display in parallel several video streams received from web cameras. For example, the expert may operate a web camera showing an object on his desk or an object he holds in addition to a web camera showing his face, and the video streams from both cameras may be displayed side by side or otherwise simultaneously or otherwise, as may be desired. It will be noted that the user interface of the present invention may rely on basic programs usually installed on a commonly used computer, such as a Personal Computer (PC). Such a basic program may be, for example, a Flash player, e.g., Adobe Flash. If a Flash player is installed the installation of the user interface for both sides expert and customer is made easy and short and does not require downloading of a special program.

The customer and the expert may view together media files and/or streams and/or view documents and modify them. In some embodiments of the present invention, the expert or the client may control the media player. The media may be displayed according to the control commands operable by both customer's media application 108 and expert's media application 128 synchronously.

In some embodiments of the present invention, the expert and or the customer may choose images and/or videos from an image/video gallery 135 in application server 130, for example, for explanation, illustration, demonstration, clarification and/or any other suitable purpose. Upon choosing a file from the gallery, web application server 130 may download the file to customer's media application 108 and expert's media application 128. Additionally or alternatively, thumbnails of the images/videos in the gallery may be downloaded, for example, to expert's media application 128, for example, upon request of the expert. The Expert may choose one of the images/videos, for example, by selecting the thumbnail respective to the desired image/video. The expert may also control different attributes of the image/video, for example, size, location on desktop, alignment, and/or other attributes. The expert may also control a video player, e.g., play, stop, pause, rewind and/or fast-forward or apply any other possible control command on the video. Image/video selection and control commands entered by the expert to expert's media application 128 may be loaded to media server 140. Media server 140 may update customer's media application 108 according to image/video selection and control commands entered by the expert. For example, if an image is selected by the expert through expert's media application 128, media server 140 may update customer's media application 108 to display the selected image. If the expert enlarges the Image, media server 140 may update customer's media application 108 to enlarge the image accordingly and synchronously with the expert's enlarging command. In other example, a video may be selected by the expert through expert's media application 128. Media server 140 may update customer's media application 108 to display the selected video accordingly and synchronously with the expert's video player control commands. Additionally or alternatively, either or both customer workstation 110 and expert workstation 120 may load a document from document gallery 136 in web application server 130 in order to view it, to use it as part of a session, to modify it and to save it after modification. Additionally or alternatively either or both customer and expert may activate an application loaded from application gallery 137 in web application server 130 in order to use it concurrently and synchronously. An application from application gallery 137 may reside in web application server 130 yet it may alternatively reside somewhere else and be accessed via web application server 130.

Some embodiments of the present invention may provide a virtual drawing device, for example, a virtual pen (shown in FIGS. 2A and 2B) which may be controlled, for example, by a mouse or/and optical pen or other suitable means. The drawing device may enable marking and/or sketching on a virtual whiteboard or on an image or video stream viewed by the customer and expert synchronously. The customer and/or expert may use the virtual pen, for example, for explanation, illustration, demonstration, indication, selection, clarification and/or any other suitable purpose, on the virtual whiteboard or image or video stream. Media server 140 may receive the movement commands of the drawing device and synchronize customer's media application 108 and expert's media application 128, so that the drawing will be displayed in both of them on the virtual whiteboard or image or video stream synchronously. For example, if the expert draws a line on a virtual whiteboard or image or video stream, the media server may receive indication on the drawing device movement and update customer's media application 108 which may display the line to the customer accordingly and synchronously with the line drawn by the expert. In some embodiments, during a video presentation the client may indicate a certain element in a video frame, for example, by the drawing device, and, for example, request further explanation from the expert.

Further in some embodiments, the expert may present several possibilities to the customer which may indicate the desired/correct possibility, for example, by the drawing device. For example, a patient may consult a doctor regarding a mole. The doctor may present several pictures of moles from a gallery of pictures and the patient may mark the picture which represents most accurately the mole he consults about. Alternatively, the patient may send a picture of the mole to the doctor and they may view it synchronously and put marks on it using the drawing device. Alternatively or additionally the patient may present the mole to the doctor via video stream.

Reference is now made to FIGS. 2A and 2B, which are schematic exemplary illustrations of an expert's user interface 200 of expert's media program 128 shown in FIG. 1 and customer's user interface 300 of customer's media program 108 shown in FIG. 1 according to some embodiments of the present invention. The present invention is not limited to the order and alignment of the elements in these figures. Additionally, expert's user interface 200 and customer's user interface 300 may include other elements in addition or/and alternative equivalent elements instead of the elements of expert's user interface 200 and customer's user interface 300. Expert's user interface 200 and customer's user interface 300 may include different areas on the desktop in which different features of the present invention may be displayed. Expert's user interface 200 may include, for example, a payment status area 210, a time meter area 220, a stop/resume session button 230, a ‘send a file’ button 240, a files links area 245, an expert video display area 250, a client video display area 255, a gallery browser area 260, a whiteboard/video/image area 270, a video/image controls area 275, a virtual pen 277 and a chat area 280. Customer's user interface 300 may include, for example, a payment status area 310, a time meter area 320, a send a file button 340, an incoming files links area 345, an expert video display area 350, a client video display area 355, a whiteboard/video/image area 370, a video/image controls area 375, a virtual pen 377 and a chat area 380.

Payment status area 310 may display the payment status of the customer, for example, by a displayed payment meter (not shown). The customer may control the payment for the session, for example by a meter on/off button (not shown) inside payment status area 310. For example, when an intermission in the session occurs. Payment status area 210 may display indication for the expert on payment status of the customer. Time meter areas 220 and 320 may display time indication, for example, indication on the time passed since the session has began or the time left till the end of the session. For example, the duration of the session may be determined according to the payment status shown in payment status areas 210 and 310. The expert may also decide to stop or resume a session, for example, based on the payment status of the customer, for example, by using stop/resume session button 230.

The expert and/or the customer may share files with each other, for example, text files, image files, audio files, video files and/or any other suitable files, for example, for purposes of example, illustration, demonstration, explanation and or/and other purpose facilitating the consultation. The expert and/or the customer may choose the file to share and press send a file button 240 or 340 respectively in order to upload the file to the web application server, for example, as described in details above with reference to FIG. 1. The file may be chosen, for example, from the local work station, e.g., the personal computer of the expert or the customer respectively. The possibility to share files during the consultation session according to embodiments of the present invention may facilitate the consultation and may enable imitation of a face to face meeting, wherein the expert and or the customer can freely and easily show each other pictures, videos, models, presentations and/or any other exhibits which may facilitate explanation and/or illustration during the consultation session.

When a file is uploaded to the application web server, the media server may be updated that a new file has been uploaded, as described with detail above with reference to FIG. 1. The media server may synchronize a notice about the new uploaded file and/or an appearance of a link to the uploaded file in the incoming files links areas 345 and/or 245 in customer's user interface 300 and/or expert's user interface 200 respectively. The customer and/or the expert may then open the uploaded files by using, for example, a link in incoming files link areas 345 and/or 245.

Expert video/image areas 250 and 350 may display substantially real-time video stream showing the expert during the session. The video stream may be received by the expert's media program 128 (shown in FIG. 1), for example, from a web camera (not shown). In some embodiments expert video/image areas 250 and 350 may display a still image of the expert, for example, when a video stream is not available or when the performance of a link between the expert and the client does not allow. The video stream and/or the steel image of the expert may be communicated to the media server, which may send it to the customer media program 108 (shown in FIG. 1) and synchronize it to display the video stream and/or the steel image substantially in real-time during the session, in expert video/image area 350.

Client video/image areas 255 and 355 may display substantially real-time video stream showing the client during the session. The video stream may be received by the client's media program 108 (shown in FIG. 1), for example, from a web camera (not shown). In some embodiments, client video/image areas 255 and 355 may display a still image of the client, for example, when a video stream is not available. The video stream and/or the steel image of the client may be communicated to the media server, which may send it to the expert media program 128 (shown in FIG. 1) and synchronize it to display the video stream and/or the steel image substantially in real-time during the session, in client video/image area 255. This may create for the customer and for the expert an environment similar to a real face to face meeting, wherein they can see each other's faces and facial expressions.

User interfaces 200 and 300 may include additional video/image areas (not shown) wherein additional video streams may be displayed, for example, from additional cameras. For example, in addition to a video stream showing the expert face, an additional video stream may be displayed, for example, showing the expert's hand, for example when he holds an object and explains about it or by it.

The customer and the expert may view together media files and/or streams. Media files and/or streams may be displayed in whiteboard/video/image areas 270 and 370. In some embodiments of the present invention, the expert or the client may control the media player, for example by controls in the control areas 275 and 375. The media may be displayed according to the control commands both by customer's media application 108 and expert's media application 128 synchronously.

In some embodiments of the present invention, the expert and or the customer may choose images and/or videos from an image/video gallery in application server 130, for example, for explanation, illustration, demonstration, clarification and/or any other suitable purpose. Gallery browser area 260 may include, for example links and/or thumbnails of images, videos, text files and other files which may exist in web application server 130. Upon choosing a file from the gallery, web application server 130 may download the file to customer's media application 108 and expert's media application 128. Additionally or alternatively, thumbnails of the images/videos in the gallery may be downloaded, for example, to expert's media application 128, for example, upon request of the expert. The thumbnails may be displayed in gallery browser area 260. The Expert may choose one of the images/videos, for example, by selecting a thumbnail or a link of the desired image/video. The expert may also control different attributes of the image/video, for example, size, location on desktop, alignment, and/or other attributes by controls in control area 275. The expert may also control a video player, e.g., play, stop, pause, rewind and/or fast-forward or apply any other possible control command on the video, by controls in control area 275. Image/video selection and control commands entered by the expert to expert's media application 128 may be loaded to media server 140. Media server 140 may update customer's media application 108 according to image/video selection and control commands entered by the expert. For example, if an image is selected by the expert through expert's media application 128, the image may be displayed in whiteboard/video/image area 270 and media server 140 may update customer's media application 108 to display the selected image, for example, in whiteboard/video/image area 370. If the expert enlarges the Image, the image may be enlarged in whiteboard/video/image area 270 and media server 140 may update customer's media application 108 to enlarge the image accordingly and synchronously with the expert's enlarging command in whiteboard/video/image area 370. In other example, a video may be selected by the expert through expert's media application 128. The video may be displayed in whiteboard/video/image area 270 according to the expert's video player control commands and media server 140 may update customer's media application 108 to display the selected video accordingly and synchronously with the expert's video player control commands, in whiteboard/video/image area 370.

In some embodiments, the client may also control images and videos by using controls in control area 375. Whiteboard/video/image areas 270 and 370 may be updated accordingly, in the method described with detail above.

Some embodiments of the present invention may provide a virtual drawing device, for example, virtual pens 277 and 377 which may be controlled, for example, by a mouse or/and optical pen or other suitable means. Virtual pens 277 and 377 may enable marking and/or sketching on a virtual whiteboard or on an image or video stream viewed by the customer and expert synchronously, for example, in whiteboard/video/image areas 270 and 370. Virtual pens 277 and 377 may appear for example, by choosing a virtual pen option in control area 275 and 375 respectively. The customer and/or expert may use virtual pens 277 and 377, for example, for explanation, illustration, demonstration, indication, selection, clarification and/or any other suitable purpose, for example, in whiteboard/video/image areas 270 and 370. Media server 140 may receive the movement commands of virtual pens 277 and 377 and synchronize customer's media application 108 and expert's media application 128, so that the drawing will be displayed in both of them in whiteboard/video/image areas 270 and 370 synchronously. For example, if the expert draws a line in whiteboard/video/image area 270, the media server may receive indication on movement of virtual pen 277 and update customer's media application 108 which may display the line to the customer in whiteboard/video/image area 370 accordingly and synchronously with the line drawn by the expert. The possibility to sketch on a shared whiteboard, images and videos may facilitate the easy communication and make it similar as possible to a direct encounter between the customer and the expert.

The client and expert may also have a synchronous real-time typed conversation which may be displayed in chat areas 280 and 380 respectively and may be synchronized by media server 140 and/or by web application server 130 in a similar manner to the described above. By this and by the other possibilities enabled by embodiments of the present invention, examples of which described herein above, the communication between the customer and expert is as convenient as possible and similar as possible to a face-to-face consultation meeting.

According to embodiments of the present invention customer media program 108 and/or expert media program 128 may include public applicant programming interface (API) that may enable the parties, e.g. a customer and/or an expert, to add their own flash applications to the applications available via application gallery 137 that they can use during a session. We defined and documented A standard open API in ActionScript 2 (AS2) (Flash programming language) may be defined, that allows a programmer to easily convert any AS2 application to be synchronizeable. This is done by simplification of a Flash Media Server Shared Objects mechanism. Users of the system of the present invention may create their own custom made applications (like financial calculators, questionnaires etc.) and add them to their application gallery and use them during a session. This mechanism is in that it enables to conduct such activities (like instructing a customer using a calculator for example) in a more efficient way, while previously used techniques such as “desktop sharing” required significantly larger bandwidth.

One possible application of embodiments of the present invention may include an on line sales session. For example, a customer may enter a web site which sales certain kind of goods, for example, electric devices, furniture, jewelries, antiques, works of art, fashion products or any other suitable objects. The customer may have the possibility to book a virtual appointment with a sales person. The customer may be directed to a web page which may include the features of user interface 300 described above. The customer may describe to the sales person the item he wants to purchase. The customer may see the sales person in real time during the sales session. The customer may receive from the sales person information about items by, for example, oral description, video presentation, image examples, sketches, typed chat, shared files and/or other suitable means as described with detail above. The customer may communicate with the sales person by video, audio, sketches, typed chat, shared files, and/or other suitable means as described with detail above. The customer may insert the details of the method of payment, for example, credit card details. The payment may be charged, for example, according to the duration of the session. According to some embodiments the sales session may comprise simulation of a try-on of an object by the client, for example, by simulating the view of the client once he/she wears the object. For example, if a client wishes to try-on a ring from a jewelry store the ring may visually be simulated optically by combining a still/video image of the ring received from the expert's user interface 200 with a still/video image of the client's hand, received from the client's user interface 300, so as to enrich the experience of purchasing.

Another possible application of embodiments of the present invention may include online tutorials. Embodiments of the present invention may enable online learning of substantially any subject, for example, cooking, magic tricks, languages, substantially any school subject and any other suitable subject. Any feature of embodiments of the present invention described above may be used in the online tutorials as required and/or desired.

Embodiments of the present invention may enable on-line consultation substantially with any kind of expert, for example, physician, veterinarian, plumber, technician (for example, of electrical devices), technical support person and any other suitable expert.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for enabling online information collaboration in real time, comprising:
a customer work station including a customer media application;
an expert work station including an expert media application; and
a web application server to serve synchronized files to said customer work station and said expert work station; wherein said synchronized files are synchronizable in at least two directions.

2. The system of claim 1, further comprising a media server to serve synchronized media files to said customer work station and said expert work station.

3. The system of claim 1, wherein said customer media application and said expert media application are web browser plug-in software.

4. The system of claim 1, wherein said media server is modified to synchronize said customer media application and said expert media application, wherein said synchronization is two-way synchronization.

5. The system of claim 1, wherein said synchronized files includes synchronous presentation on both said customer media application and said expert media application of files selected from the set consisting of video, audio, chat, and/or other media files.

6. The system of claim 1, wherein any said synchronized files are usable by said customer media application, even when said customer work station does not have dedicated software to run a specific files type being synchronized.

7. The system of claim 1, wherein said application server is adapted to enable an expert to control payment for a session during said session.

8. The system of claim 7, wherein said control of payment includes presenting a synchronized payment status that is updatable in real time.

9. The system of claim 1, wherein said customer media application and said expert media application include a public application programming interface (API) to enable said customer and/or said expert to add external applications to said system during a session.

10. The system of claim 1, wherein said synchronized files are checked for viruses prior to sharing of said files.

11. The system of claim 1, wherein two or more live screens may be viewable simultaneously.

12. The system of claim 1, wherein said media applications include virtual drawing boards and drawing tools on both said customer media application and said expert media application, said virtual drawing boards and drawing tools being synchronized bi-directionally.

13. A system for enabling real time co-browsing between remote users, comprising:
a first work station including a first media application;
a second work station including said first media application;
a web application server to serve bi-directional synchronized files to said work stations, wherein said synchronized files are usable without requiring prior application setup; and
a media server to serve bi-directional synchronized media files to said work stations.

14. A method for enabling real time synchronized application sharing between two or more remote parties, comprising:
opening a session between a first and a second user;
introducing a file by a first user, said file being introduced substantially in real time to said second user; synchronizing said file on the workstations of said first user and said second user;
loading at least one media stream received from said first user or said second user to a media server; and
synchronizing said media stream within said file on said workstations of said first user and said second user.

15. The method of claim 14, further comprising:
requesting payment by said first user; and
controlling payment substantially in real time by said first user during said session.
